(19) United States
(12) Patent Application Publication
(10) Pub. No.: US 2026/0208803 A1
(43) Pub. Date: Jul. 23, 2026

(54) LOW DENSITY RUBBER COMPOSITION COMPRISING MULTI-WALLED CARBON NANOTUBES AND USE THEREOF FOR TRACKS OR TIRES

(71) Applicant: CAMSO INC., Magog (CA)

(72) Inventor: KEUN-WAN PARK, Magog (CA)

(21) Appl. No.: 19/140,584

(22) PCT Filed: Dec. 20, 2023
(86) PCT No.: PCT/CA2023/051718

§ 371 Date: Jun. 18, 2025

Related U.S. Application Data
(60) Provisional application No. 63/476,486, filed on Dec. 21, 2022.

(51) Int. Cl. B62D 55/24; C08K 3/04; C08K 3/06; C08K 3/22; C08K 3/30; C08K 5/09; C08K 5/44; C08K 7/08; C08L 9/00

(52) U.S. Cl. CPC B62D 55/24; C08K 3/041; C08K 3/06; C08K 3/22; C08K 3/30; C08K 5/09; C08K 5/44; C08K 7/08; C08L 9/00; C08K 2003/2296; C08K 2003/3009

(57) ABSTRACT

A rubber composition based on: 65-80 wt % of an elastomeric material comprising a mixture of a polyisoprene, butadiene rubber, and polyolefin elastomer; 1-7 wt % MWCNT; 3-25 wt % carbon black; and 0-2 wt % fibers; wherein the wt % are based on the total weight the composition; the MWCNT having an average length ranging from 2-40 μm. Also disclosed is a rubber composition based on: 25-35 wt % of polyisoprene; 17-27 wt % of butadiene rubber; 3-9 wt % of polyolefin elastomer; 10-15 wt % of high styrene resin; 1-7 wt % of MWCNT; 3-25 wt % carbon black; and 0-2 wt % fibers. The composition is useful for manufacturing tracks or tires for vehicles, such as snowmobiles, snow bikes, All-Terrain Vehicles or Utility Terrain Vehicles. A track or tire for a vehicle comprising the rubber composition in vulcanized form is also disclosed.

### TECHNICAL FIELD

This disclosure generally relates to a rubber composition such as for track or tires for vehicles (e.g., snowmobile, snow bikes, ATV, UTV, etc.), and to tracks or tires based on such composition. More specifically, the rubber composition is based on a rubber matrix and multi-walled carbon nanotubes and presents a low density.

### BACKGROUND

Certain off-road vehicles, such as recreative vehicles (e.g., snowmobile, snow bikes, All-Terrain Vehicle (ATV) or Utility Terrain Vehicle (UTV), etc.) may be equipped with a rubber track system (e.g., endless track) or tires that enhance traction and floatation on soft, wet, and/or irregular ground (e.g., soil, mud, dust, sand, ice, snow, etc.) during operation.

There exist different types of tracks, including for instance mountain tracks with high profile intended to come into contact with snow, trail tracks with low profile intended to come into contact with mud and/or snow, and tracks intended to come into contact with dust and/or sand. Tracks for snowmobiles are for instance described in Applicant's own patent publications US20210221453 or in WO2014/056085.

When designing such track systems or tires, one challenge is to reduce the weight of the carcass and tread profile. This is useful for improving speed, longevity, or climbing the slop of mountains more easily for instance. Solutions have been proposed to reduce the weight of tracks particularly, which generally involve physical modifications such as modifying the pattern of tracks or shape of tracks.

Chemical modifications of the carcass and tread profile rubber composition itself, to reduce the tracks or tires weight, while keeping performance and processability, can be challenging. Specifically, the density reduction may impact on the rigidity and/or durability and/or anti-crack resistance. Reducing the amount of filler (e.g., carbon black) in the composition could be contemplated as an avenue to reduce the composition density, however, a sufficient amount of filler is necessary to obtain good rigidity and crack resistance. It can thus be challenging to lower the rubber composition density while maintaining good track or tire properties.

### SUMMARY

According to one aspect, there is provided a rubber composition based on:
65 wt % to 80 wt % of an elastomeric material comprising at least a mixture of a polyisoprene, a butadiene rubber, and a polyolefin elastomer;
1 wt % to 7 wt % of multi-walled carbon nanotubes;
3 wt % to 25 wt % of carbon black; and
0 to 2 wt % of fibers,
wherein the weight percentages (wt %) are based on the total weight the composition; and
wherein the multi-walled carbon nanotubes have an average length ranging from 2 μm to 40 μm.

In some embodiments, the elastomeric material of the rubber composition further comprises 10 wt % to 15 wt % of a high styrene resin. In some embodiments, the elastomeric material comprises 25 wt % to 35 wt % of the polyisoprene; 17 wt % to 27 wt % of the butadiene rubber; and 3 wt % to 9 wt % of the polyolefin elastomer. In some embodiments, the elastomeric material further comprises 10 wt % to 15 wt % of a high styrene resin.

According to another aspect, there is provided a rubber composition based on:
25 wt % to 35 wt % of a polyisoprene;
17 wt % to 27 wt % of a butadiene rubber;
3 wt % to 9 wt % of a polyolefin elastomer;
10 wt % to 15 wt % of a high styrene resin;
1 wt % to 7 wt % of multi-walled carbon nanotubes;
3 wt % to 25 wt % of carbon black; and
0 to 2 wt % of fibers;
wherein the weight percentages (wt %) are based on the total weight the composition.

In some embodiments, the rubber composition is characterized in that the multi-walled carbon nanotubes have an average length ranging from 2 μm to 40 μm.

In some embodiments, the rubber composition is characterized in that the polyisoprene is selected from the group consisting of natural rubber (NR), synthetic polyisoprenes, and mixtures thereof, preferably the polyisoprene is natural rubber.

In some embodiments, the rubber composition is characterized in that the polyolefin elastomer comprises poly octene-ethylene.

In some embodiments, the rubber composition has a density ranging from 1.02 kg/L to 1.095 kg/L, preferably from 1.02 kg/L to 1.05 kg/L.

In some embodiments, the rubber composition is characterized in that the multi-walled carbon nanotubes have an average length ranging from 5 μm to 35 μm.

In some embodiments, the rubber composition is characterized in that the multi-walled carbon nanotubes have a BET specific surface area ranging from 200 m²/g to 250 m²/g.

In some embodiments, the rubber composition is characterized in that the multi-walled carbon nanotubes have an average diameter ranging from 10 nm to 20 nm, preferably from 12 nm to 20 nm.

In some embodiments, the rubber composition comprises from 2 wt % to 7 wt % of multi-walled carbon nanotubes, preferably from 3 wt % to 7 wt % of multi-walled carbon nanotubes, more preferably from 4 wt % to 7 wt % of multi-walled carbon nanotubes, most preferably from 5 wt % to 7 wt % of multi-walled carbon nanotubes.

In some embodiments, the rubber comprises from 3 wt % to 9 wt % of carbon black, preferably from 3 wt % to 7 wt % of carbon black.

In some embodiments, the rubber composition is characterized in that a weight ratio of the multi-walled carbon nanotubes to the carbon black in the composition ranges from 1.09 to 1.2, preferably from 1.09 to 1.16.

In some embodiments, the rubber composition is characterized in that the fibers comprise polyester fibers.

In some embodiments, the rubber composition comprises from 1 wt % to 2 wt % of fibers, preferably from 1.5 wt % to 1.8 wt % of fibers.

In some embodiments, the rubber composition comprises from 27 wt % to 33 wt % of the polyisoprene, and 18 wt % to 25 wt % of the butadiene rubber.

According to another aspect, there is provided a use of the rubber composition as defined herein, for manufacturing a track or tire for a vehicle, such as an off-road vehicle, wherein the vehicle is a snowmobile, a snow bike, All-Terrain Vehicle (ATV) or Utility Terrain Vehicle (UTV).

According to another aspect, there is provided a track or tire for a vehicle comprising the rubber composition as defined herein in vulcanized form.

In some embodiments, the track is a snowmobile track.

### DETAILED DESCRIPTION

The present disclosure primarily relates to a rubber composition such as for track or tires for vehicles (e.g., snowmobile, snow bikes, ATV, UTV, etc.), and to tracks or tires based on such composition. The rubber composition and products formed therefrom will be described in more detailed below. Definitions of certain terms used in the present description and claims are provided herein below.

As used herein the singular forms “a”, “an”, and “the” include plural referents unless the context clearly dictates otherwise. Thus, for example, reference to “a cell” includes a plurality of such cells and reference to “the culture” includes reference to one or more cultures and equivalents thereof known to those skilled in the art, and so forth. All technical and scientific terms used herein have the same meaning as commonly understood to one of ordinary skill in the art to which this invention belongs unless clearly indicated otherwise.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, un-recited elements.

The expression “composition based on” should be understood as meaning a composition comprising the mixture and/or the product of the in situ reaction of the various constituents used, some of these constituents being able to react and/or being intended to react with one another, at least partially, during the various phases of manufacture of the composition; it thus being possible for the composition to be in the completely or partially crosslinked state or in the noncrosslinked state.

The term “phr” used herein means “part per hundred parts of elastomer”, in mass. This unit can be used to express the proportion of certain constituents of the rubber composition described herein.

In the present document, unless expressly indicated otherwise, all the percentages (%) indicated are percentages by weight (wt %). The percentages by weight of the different constituents of the rubber composition are thus based on the total weight of composition. It is understood that the sum of the percentages by weight of the composition constituents amount to 100.

Furthermore, any interval of values denoted by the expression “between a and b” represents the range of values extending from more than a to less than b (i.e., limits a and b excluded), whereas any interval of values denoted by the expression “from a to b” means the range of values extending from a up to b (i.e., including the strict limits a and b).

The carbon-comprising compounds mentioned in the description can be of fossil or biobased origin. In the latter case, they may, partially or completely, result from biomass or be obtained from renewable starting materials resulting from biomass. Polymers, plasticizers, fillers, and the like, are concerned in particular.

All the values for glass transition temperature “Tg” described in the present document are measured in a known manner by DSC (Differential Scanning calorimetry) according to Standard ASTM D3418 (1999).

### Rubber Composition

In some embodiments, there is thus provided a rubber composition based on at least an elastomeric material, a filler such as carbon black and multi-walled carbon nanotubes (MWCNTs). The elastomeric material comprises at least a mixture of a polyisoprene, a butadiene rubber (BR), and a polyolefin elastomer. It has been shown that by adding MWCNTs in a certain amount and/or MWCNTs having a particular length, it was possible to reduce the content of filler, e.g., carbon black in the rubber composition, thereby reducing the density of the composition without impacting or with limited impact on the rigidity of the final product obtained from the composition. In addition, in some embodiments, the rubber composition can comprise fibers, if required, to further balance on the carbon black content reduction and allow obtaining a product with a suitable rigidity.

In some embodiments, the rubber composition can thus be based on the elastomeric material in an amount ranging from 65 wt % to 80 wt %, from 1 wt % to 7 wt % MWCNTs, from 3 wt % to 25 wt % carbon black; and up 2 wt % fibers. In some embodiments, the MWCNTs can present an average length ranging from 2 μm to 40 μm. By “average length”, it is meant that a majority of each individual MWCNT has a length having a value within the defined range but do not exclude individual MWCNTs having a length below the minimum value of the defined range or above the maximum value of the defined range. Further details on the MWCNTs that can be used in the present rubber composition will be provided below.

In some embodiments, the rubber composition can be characterized in that the elastomeric material or matrix comprises from 25 wt % to 35 wt % of polyisoprene, from 17 wt % to 27 wt % of butadiene rubber, and from 3 wt % to 9 wt % of a polyolefin elastomer. The elastomeric material, in addition to including polyisoprene, butadiene rubber, and a polyolefin elastomer, can further include a high styrene resin, and optional additional resins and/or elastomeric components, as will be detailed below. In some embodiments, the rubber composition can comprise from 25 wt % to 35 wt % of polyisoprene, from 17 wt % to 27 wt % of butadiene rubber, from 3 wt % to 9 wt % of a polyolefin elastomer, and from 10 wt % to 15 wt % of a high styrene resin.

As mentioned above, the elastomeric material can generally represent 65 wt % to 80 wt % of the rubber composition. In some embodiments, the rubber composition can comprise 65 wt % to 75 wt % elastomeric material, or 65 wt % to 70 wt % elastomeric material, or 70 wt % to 80 wt % elastomeric material, or 70 wt % to 75 wt % elastomeric material, or any value within these ranges. Hence, the content of elastomeric material in the rubber composition can be 65 wt %, 66 wt %, 67 wt %, 68 wt %, 69 wt %, 70 wt %, 71 wt %, 72 wt %, 73 wt %, 74 wt %, 75 wt %, 76 wt %, 77 wt %, 78 wt %, 79 wt %, or 80 wt %.

The elastomeric material comprises at least one polyisoprene. Advantageously, the polyisoprene can comprise a content by weight of 1,4-cis bonds of at least 90%, preferably at least 98%, of the weight of the polyisoprene. In preferred embodiments, the polyisoprene is a natural rubber. In some embodiments, the polyisoprene is selected from the group consisting of natural rubber (NR), synthetic polyisoprenes, and mixtures thereof. Preferably, the polyisoprene is a natural rubber. The elastomeric material can comprise one type of natural rubber or a mixture of natural rubbers from different origins. In some embodiments, the polyisoprene can have a molecular weight ranging from 1,000,000 g/mol to 1,500,000 g/mol, preferably from 1,000,000 g/mol to 1,200,000 g/mol. As mentioned above, the content of polyisoprenein the rubber composition can range from 25 wt % to 35 wt %. In some embodiments, the content of polyisoprene in the rubber composition can be from 25 wt % to 30 wt %, or from 27 wt % to 30 wt %, or from 27 wt % to 33 wt %, or from 27 wt % to 35 wt %, or from 30 wt % to 35 wt %, or any value within these ranges. Hence, the content in polyisoprene in the composition can be 25 wt %, 26 wt %, 27 wt %, 28 wt %, 29 wt %, 30 wt %, 31 wt %, 32 wt %, 33 wt %, 34 wt %, or 35 wt %.

The elastomeric material further comprises a butadiene rubber component. “Butadiene rubber” (BR) as used herein refers to one or more polymers based on butadiene, i.e., a “polybutadiene”. Polybutadiene is a well-known rubber which is manufactured by polymerizing the 1,3-butadiene monomer (typically a homopolymerization) in a solution polymerization process using suitable catalysts known to a person skilled in the art. Due to the two double bonds present in the butadiene monomer, the resulting polybutadiene can comprise three different forms: a cis-1,4-, a trans-1,4- and a vinyl-1,2-polybutadiene. The cis-1,4- and trans-1,4-elastomers are formed by monomers connecting end-to-end, while the vinyl-1,2-elastomer is formed by monomers connecting between the ends of the monomer. The choice of the catalyst and the temperature of the process are known as the variables generally used to control the content of cis-1,4-bonds of the polybutadiene. Advantageously, the polybutadiene can have a content (mol %) of cis-1,4-links of greater than 90%, more preferentially of greater than 95%. Polybutadienes of this type can be produced using a neodymium catalyst in a manner well known to a person skilled in the art, for example according to a process described in the documents JP 60/23406 A and WO 03/097708 A1. Polybutadienes of this type are usually referred to as “neodymium-catalyzed polybutadiene rubber” (Nd-BR) and may also be commercially available. Advantageously, the glass transition temperature of the polybutadiene is within a range extending from −110° C. to −80° C. In some embodiments, the butadiene rubber can have a molecular weight ranging from 450,000 g/mol to 650,000 g/mol, or from 500,000 g/mol to 650,000 g/mol, or 550,000 g/mol to 650,000 g/mol, preferably from 600,000 g/mol to 650,000 g/mol. For instance, the butadiene rubber can comprise a neodymium-catalyzed polybutadiene rubber having a molecular weight ranging from 600,000 g/mol to 650,000 g/mol. As mentioned above, the content of butadiene rubber in the rubber composition can range from 17 wt % to 27 wt %, or from 18 wt % to 25 wt %. In some embodiments, the content of butadiene rubber in the rubber composition can be from 17 wt % to 25 wt %, or from 18 wt % to 25 wt %, or from 17 wt % to 20 wt %, or from 18 wt % to 20 wt %, or from 20 wt % to 25 wt %, or any value within these ranges. Hence, the content of butadiene rubber in the rubber composition can be 17 wt %, 18 wt %, 19 wt %, 20 wt %, 21 wt %, 22 wt %, 23 wt %, 24 wt %, 25 wt %, 26 wt %, or 27 wt %.

The elastomeric material of the rubber composition also comprises a polyolefin elastomer component. “Polyolefin elastomer” (also referred to as “POE” herein) refers to a product comprising a homopolymer or copolymer based on olefins, i.e., based on monomeric entities comprising at least one double bond. The POE can thus comprise a polymer based at least on ethylene as a first olefin. In some embodiments, the POE can be a copolymer of ethylene and a second olefin comprising at least 3 carbon atoms, wherein the second olefin preferably includes only one double bond. In some embodiments, the POE can include an octene-ethylene copolymer. In certain embodiments, the POE can have a molecular weight ranging from 1,000 g/mol to 50,0000 g/mol, or from 5,000 g/mol to 500,000 g/mol, or from 10,000 g/mol to 500,000 g/mol, or from 15,000 g/mol to 500,000 g/mol, or from 15,000 g/mol to 450,000 g/mol, or from 15,000 g/mol to 400,000 g/mol, or from 15,000 g/mol to 350,000 g/mol, or from 15,000 g/mol to 300,000 g/mol, or from 15,000 g/mol to 250,000 g/mol, or from 15,000 g/mol to 200,000 g/mol, or from 15,000 g/mol to 150,000 g/mol, or from 15,000 g/mol to 100,000 g/mol, preferably from 15,000 g/mol to 50,000 g/mol. Polyolefin elastomers suitable for being used in the rubber composition are commercially available. Alternatively, it is possible to synthesize the polyolefin elastomers using conventional methods.

The elastomeric material of the rubber composition can further comprise a high styrene resin, for instance in an amount from 10 wt % to 15 wt % based on the weight of the rubber composition. “High styrene resin” (HSR) as used herein, refers to a resin based on styrene and generally comprising a styrene-butadiene copolymer with a high bound styrene content. Styrene-butadiene copolymers are also commonly referred to as “SBR”. In some embodiments, the high styrene resin has a bound styrene content from 67 wt % to 69 wt %, preferably from 68 wt % High styrene resin of various grades are commercially available and can be used for preparing the rubber composition. Alternatively, it is possible to synthesize the high styrene resin using conventional methods. In some embodiments, the HSR can have a molecular weight ranging from 500,000 g/mol to 600,000 g/mol, or from 500,000 g/mol to 550,000 g/mol, or from 500,000 g/mol to 540,000 g/mol, or from 500,000 g/mol to 530,000 g/mol, or from 500,000 g/mol to 520,000 g/mol, or from 500,000 g/mol to 510,000 g/mol, e.g., 500,000 g/mol. As mentioned above, the content of HSR in the rubber composition can range from 10 wt % to 15 wt %. In some embodiments, the content of HSR in the rubber composition can range from 11 wt % to 13 wt % or can be any value within the above-mentioned ranges. Hence, the content of HSR in the rubber composition can be 10 wt %, 11 wt %, 12 wt %, 13 wt %, 14 wt %, or 15 wt %.

The rubber composition includes a reinforcing filler component such as carbon black, which is conventionally used in the manufacture of vehicle tracks or tires. The content of carbon black in the rubber composition can be within a range extending from 3 wt % to 25 wt %, preferably from 3 wt % to 9 wt %, most preferably from 3 wt % to 7 wt %. In some embodiments, the carbon black content in the rubber composition can thus be from 3 wt % to 25 wt %, or from 3 wt % to 20 wt %, or from 3 wt % to 15 wt %, or from 3 wt % to 10 wt %, or from 3 wt % to 9 wt %, or from 3 wt % to 8 wt %, or from 3 wt % to 7 wt %, or from 3 wt % to 6 wt %, or from 3 wt % to 5 wt %, or from 3 wt % to 4 wt %. The carbon content in the rubber composition can be 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, or 25 wt %. The carbon blacks which can be used in the present rubber composition can be any carbon black conventionally used in tracks, in tires or their treads (e.g., “tire-grade” blacks). Among the latter, mention can be made more particularly to the reinforcing carbon blacks of the 100, 200 and 300 series, or the blacks of the 500, 600 or 700 series (ASTM grades), for instance the N115, N134, N231, N234, N326, N330, N339, N347, N375, N550, N683 and N772 carbon blacks. In some embodiments, the rubber composition can include carbon blacks selected from N115, N134, N231, and N234 carbon blacks, or any mixtures thereof. Accordingly, the carbon blacks can have a BET specific surface (i.e., the surface area determined according to the Brunauer-Emmett-Teller technique) of more than or equal to 100 m²/g, for instance from 100 to 150 m²/g. The BET specific surface of carbon blacks is measured according to standard D6556-10 [multipoint method (at least 5 points)—gas: nitrogen—relative pressure range P/PO: 0.1 to 0.3]. For instance, the rubber composition can include from 3 wt % to 9 wt % of any one of N115, N134, N231, and N234 carbon blacks or any mixture thereof. These carbon blacks can be used in the isolated state, as available commercially, or in any other form, for example as support for some of the rubber additives used. The carbon blacks can, for example, be already incorporated in the polyisoprene (e.g., natural rubber), in the butadiene rubber, or in a mixture thereof, in the form of a masterbatch. In some embodiments, the carbon black used in the present rubber composition can have a density ranging from 1.7 to 1.9.

In some embodiments, the rubber composition can include fibers as additional reinforcing material. Any type of fibers conventionally used in the field can be present in the rubber composition including, without being limited to, rayon, nylon, polyester, aramid fibers, and any mixtures thereof. In some embodiments, the fibers used in the present rubber composition are preferably polyester fibers. In some embodiments, the density of the fibers used in the present rubber composition can range from 1.2 to 1.6, or from 1.2 to 1.5, or from 1.2 to 1.4, or from 1.2 to 1.3. In some embodiments, the density of the fibers is 1.2. As mentioned above, the content of fibers in the rubber composition can be from 0 to 2 wt %. In some embodiments, the content of fibers in the rubber composition can be from 0.5 wt % to 1.8 wt %, or from 1 wt % to 1.8 wt %, or from 1.5 wt % to 1.8 wt %, or can be any value within these ranges. Hence, when fibers are present in the rubber composition, their content can be 0.1 wt %, 0.2 wt %, 0.3 wt %, 0.4 wt %, 0.5 wt %, 0.6 wt %, 0.7 wt %, 0.8 wt %, 0.9 wt %, 1 wt %, 1.1 wt %, 1.2 wt %, 1.3 wt %, 1.4 wt %, or 1.5 wt %, 1.6 wt %, 1.7 wt %, 1.8 wt %, 1.9 wt %, or 2 wt %. As for carbon black, the fibers can be used in an isolated form or they can be already incorporated in the polyisoprene (e.g., natural rubber), in the butadiene rubber, or in a mixture thereof, in the form of a masterbatch.

As explained above, an important component of the rubber composition is the MWCNTs, an amount of which can be added to the rubber composition to be able to reduce the quantity of carbon black and provide a composition with a lowered density. In some embodiments, the content of MWCNTs in the rubber composition can range from 1 wt % to 7 wt %. In other embodiments, the content of MWCNTs in the rubber composition can be from 2 wt % to 7 wt %, or from 3 wt % to 7 wt %, or from 4 wt % to 7 wt %, or from 5 wt % to 7 wt %, or any value within these ranges. Hence, in some embodiments, the content of MWCNTs in the rubber composition can be 1 wt %, 2 wt %, 3 wt %, 4 wt %, 5 wt %, 6 wt %, or 7 wt %. In other embodiments, the rubber composition can be characterized in that the weight ratio of the MWCNTs to the carbon black in the rubber composition can range from 1.09 to 1.2, preferably from 1.09 to 1.16. In some embodiments, the weight ratio of the MWCNTs to the carbon black can be from 1.09 to 1.19, or from 1.09 to 1.18, or from 1.09 to 1.17, or any value within these ranges. Hence, the weight ratio of the MWCNTs to the carbon black can be, in some embodiments, of 1.09, 1.1, 1.11, 1.12, 1.13, 1.14, 1.15, 1.16, 1.17, 1.18, 1.19 or 1.2.

In some embodiments, the MWCNTs that can be used in the rubber composition can have an average length ranging from 2 μm to 40 μm, preferably from 5 μm to 35 μm. In some embodiments, the MWCNTs can thus have an average length ranging from 2 μm to 40 μm, from 2 μm to 35 μm, from 2 μm to 30 μm, from 2 μm to 25 μm, from 2 μm to 20 μm, from 2 μm to 15 μm, from 2 μm to 10 μm, from 5 μm to 40 μm, from 5 μm to 35 μm, from 5 μm to 30 μm, from 5 μm to 25 μm, from 5 μm to 20 μm, from 5 μm to 15 μm, from 10 μm to 40 μm, from 10 μm to 35 μm, from 10 μm to 30 μm, from 10 μm to 25 μm, from 10 μm to 20 μm, from 15 μm to 40 μm, from 15 μm to 35 μm from 15 μm to 30 μm, from 15 μm to 25 μm, from 20 μm to 40 μm, from 20 μm to 35 μm, from 20 μm to 30 μm, or the average length can be any value within these ranges. The length of the MWCNTs can have an impact of some of the rubber properties. For instance, it has been observed that when the MWCNTs present an average length from 2 μm to 40 μm, crack growth can be limited or even avoided in the final rubber product obtained from the rubber composition.

The MWCNTs used in the rubber composition can have an average diameter ranging from 10 nm to 20 nm. By “average diameter”, it is meant that a majority of each individual MWCNT has an external diameter having a value within the defined range but do not exclude individual MWCNTs having an external diameter below the minimum value of the defined range or above the maximum value of the defined range. Hence, the average diameter of the MWCNTs used in the rubber composition can range from 10 nm to 20 nm, or from 11 nm to 20 nm, or from 12 nm to 20 nm, or from 13 nm to 20 nm, or from 14 nm to 20 nm, or from 15 nm to 20 nm, or from 16 nm to 20 nm, or from 17 nm to 20 nm, or from 18 nm to 20 nm, or from 10 nm to 19 nm, or from 10 nm to 18 nm, or from 10 nm to 17 nm, or from 10 nm to 16 nm, or from 10 nm to 15 nm, or from 10 nm to 14 nm, or from 10 nm to 13 nm, or from 10 nm to 12 nm, or the average diameter can be any value within these ranges.

In some embodiments, the MWCNTs used in the rubber composition can be MWCNTs having an average length ranging from 2 μm to 10 μm and having a diameter ranging from 10 nm to 14 nm. In other embodiments, the MWCNTs used in the rubber composition can be MWCNTs having an average length ranging from 20 μm to 40 μm and having a diameter ranging from 18 nm to 20 nm.

The lengths and diameters (widths) of the MWCNTs can be determined according to standard methods. In particular, they can be determined by transmission electron microscopy (TEM).

The MWCNTs can also be characterized by their BET specific surface area, namely the surface area determined according to the Brunauer-Emmett-Teller technique. The BET specific surface area can be determined as described above with respect to the carbon blacks. In some embodiments, the MWCNTS can be selected according to their specific surface area so as minimize the heat generation by friction of the MWCNT layers and/or friction of the MWCNTs with the elastomeric matrix. In some embodiments, such heat generation can be limited and/or avoided with the use of MWCNTs presenting a BET specific surface area of 250 g/m² or lower. In some embodiments, the MWCNTs can have a BET specific surface area ranging from 200 m²/g to 250 m²/g. For instance, the MWCNTs can have a BET specific surface area of 200 m²/g, 210 m²/g, 220 m²/g, 230 m²/g, 240 m²/g, 250 m²/g, or any value comprised between these values.

The MWCNTs used in the present rubber composition are carbon nanotubes comprising multiple walls, and in some embodiments, they can include from 10 to 30 walls per carbon nanotube. In addition, the MWCNTs can either be non-functionalized or functionalized. In some embodiments, where the MWCNTs are functionalized, the functional groups can include carboxyl groups and/or hydroxyl groups, for instance.

In some embodiments, the MWCNTs used in the present rubber composition can have a bulk density ranging from 1 to 1.2 g/cm³. The “bulk density” is defined as the mass of the particles of the material divided by the total volume they occupy. The total volume includes particle volume, inter-particle void volume, and internal pore volume, which is not compacted.

The MWCNTs can be used in their isolated state or already incorporated in the polyisoprene (e.g., natural rubber (NR)), butadiene rubber (BR) or any mixture thereof, in the form of a masterbatch (MB). Masterbatches of MWCNTs in polymer matrix are commercially available, but it can also be possible to prepare masterbatches from isolated MWCNTs. In some embodiments, one can use masterbatches comprising 10 wt % to 20 wt % MWCNTs dispersed in NR or BR or any mixture thereof. Examples of commercial MWCNTs that can be used to prepare the rubber composition can include products sold by Kumho such as Kumho K-Nanos™ series. Example of masterbatches can include 10-20 wt % Kumho K-Nanos™ MWCNTs dispersed in butadiene rubber. Other examples of MWCNTs that can be used in the present rubber composition can include those sold by Arkema such as Graphistrength™ series. Masterbatches comprising 20 wt % Graphistrength™ MWCNTs dispersed in natural rubber can be used to prepare the rubber composition.

In some embodiments, the rubber composition of the present disclosure can optionally include further additives, as contemplated by a person skilled in the art, including all or some of the usual additives customarily used in elastomer compositions for tracks or tires, such as for example plasticizers (such as plasticizing oils and/or plasticizing resins), pigments, protective agents such as anti-ozone waxes, chemical anti-ozonants, antioxidants, reinforcing resins (as described for example in application WO 02/10269).

The rubber composition of the present disclosure, thanks to the use of the MWCNTs as one of its components, can have density lowered compared to some rubber compositions prepared without MWCNTs. In some embodiments, the rubber composition can be characterized by a density ranging from 1.02 kg/L to 1.095 kg/L, more preferably from 1.02 kg/L to 1.05 kg/L. In certain embodiments, the rubber composition can thus present a density ranging from 1.02 kg/L to 1.095 kg/L, or from 1.02 kg/L to 1.09 kg/L, or from 1.02 kg/L to 1.085 kg/L, or from 1.02 kg/L to 1.08 kg/L, or from 1.02 kg/L to 1.075 kg/L, or from 1.02 kg/L to 1.07 kg/L, or from 1.02 kg/L to 1.065 kg/L, or from 1.02 kg/L to 1.06 kg/L, or from 1.02 kg/L to 1.055 kg/L, or from 1.02 kg/L to 1.05 kg/L, or can have any value within these ranges. In other embodiments, the density of the rubber composition can range from 1.025 kg/L to 1.05 kg/L, or from 1.03 kg/L to 1.05 kg/L.

The rubber compositions of the present disclosure can further be characterized by their rigidity, after vulcanization, which can be expressed as the Modulus at 10% and 100%, compression modulus, and hardness. The Modulus 10% and 100% can be determined according to ASTM D-412-A, the compression modulus according to ASTM D-575-A, and the hardness according to ASTM D-2240. In some embodiments, the rubber compositions can present a 10% Modulus ranging from 1.8 to 2.4 MPa. In other embodiments, the rubber compositions can present a 100% Modulus ranging from 4.8 to 7.6 MPa. The compression modulus of the rubber compositions can for instance range from 3 to 3.6 MPa. Finally, their hardness can for example range from 76 to 85.

### Preparation of the Rubber Composition Including the Vulcanized Form Thereof

The rubber composition of the present disclosure can be manufactured in appropriate mixers using two successive preparation phases well known to a person skilled in the art.

A first phase comprises a thermomechanical working or kneading (“non-productive” phase), which can be carried out in a single thermomechanical step during which all the necessary constituents, in particular the elastomeric matrix, the carbon black and the MWCNTs, optionally in the form of masterbatches, and the optional other various additives, with the exception of the vulcanization system, are introduced into an appropriate mixer, such as a standard internal mixer (for example of ‘Banbury’ type). The incorporation of the fillers into the elastomer can be performed in one or more portions while thermomechanically kneading. The non-productive phase can be carried out at high temperature, up to a maximum temperature of from 110° C. to 200° C., preferably from 130° C. to 170° C., for a period of time generally of from 2 to 10 minutes.

A second phase comprises a mechanical working (“productive” phase), which is carried out in an external mixer, such as an open mill, after cooling the mixture obtained during the first non-productive phase down to a lower temperature, typically of less than 120° C., for example from 40° C. to 110° C. The vulcanization system is then incorporated, and the combined mixture is then mixed for a few minutes, for example from 5 to 15 min.

Such phases have been described, for example, in patent applications EP-A-0501227, EP-A-0735088, EP-A-0810258, WO 00/05300 or WO 00/05301.

The final composition thus obtained is subsequently calendered, for example in the form of a sheet or of a plaque, in particular for a laboratory characterization, or also extruded in the form of a rubber semi-finished (or profiled) element which can be used, for example, as a vehicle track or tire.

The rubber composition can be either in the raw state (before vulcanization) or in the cured state (after vulcanization), can be a semi-finished product which can be used in a track or tire.

The vulcanization of the composition can be carried out in a way known to a person skilled in the art, for example at a temperature of from 130° C. to 200° C., under pressure.

### Track and Tire

The present rubber composition can be extruded in the form of a rubber semi-finished or profiled piece which can be used, for example, as a vehicle track, such as a track for an off-road vehicle. The tracks formed from the present rubber composition can particularly be used for snowmobiles, All-Terrain Vehicle (ATV) or Utility Terrain Vehicle (UTV), preferably snowmobiles. Alternatively, the rubber composition can be extruded to form a tire for certain off-road vehicles such as snow bikes for instance.

Another object of the present invention is a track, preferably a snowmobile track, comprising a rubber composition according to the present invention.

In a known way, the track can comprise a profiled surface intended to be in contact with the ground, dust, mud, sand, ice, and/or snow when the track is in operation. The track is provided with a pattern comprising protruding elements and grooves, which generally extend transversely across the width of the track and are spaced along the circumferential length of the track. In some embodiments, the track made from the present rubber composition can be a high profile track such as a mountain snow track, intended particularly to come into contact with snow. In other embodiments, the track made from the present rubber composition can be a low profile track such as a trail track, intended to come into contact with mud and snow.

In a known way, the tire can comprise a surface intended to be in contact with the ground, dust, mud, sand, ice, and/or snow when the tire is rolling. The tire surface is provided with a pattern comprising protruding elements and grooves, e.g., pattern elements or elementary blocks delimited by various main grooves, which are longitudinal or circumferential, transverse or even oblique, it being possible for the elementary blocks in addition to comprise various incisions or thinner strips.

The tires or tracks described herein can both be in the raw state (i.e., before curing) and in the cured state (i.e., after vulcanization).

### EXAMPLES

The present section provides examples of rubber compositions according to the present disclosure together with some of their physical properties. Comparative compositions have also been prepared and their physical properties compared to those of the inventive rubber compositions.

### Preparation of the Rubber Compositions

In the examples which follow, the rubber compositions were produced as described above in the section entitled “Preparation of the rubber composition including the vulcanized form thereof”. In particular, the “non-productive” phase was carried out in a 1.6 litre tangential mixer for 5 minutes, for a mean blade speed of 100 revolutions per minute, until a maximum dropping temperature of 155° C. was reached. The “productive” phase was carried out in an internal mixer with a mean blade speed of 90 revolutions per minute, until a maximum dropping temperature of 110° C. was reached, and then in an open mill at 23° C. for 3 minutes. The vulcanization of the compositions was carried out at a temperature of 160° C. for 10 min, under pressure.

### Constituents and Properties of the Rubber Compositions

The aim of the examples presented below is to show the performance of three compositions in accordance with the present disclosure (E1 to E3) and compare the performance to comparative compositions (C1 to C3).

The nature and content of each constituent of the prepared and tested compositions are reported in Table 1 below. Unless otherwise mentioned, the values provided in Table 1 are expressed in “phr”. To obtain 100 phr, the content of rubbers, i.e., natural rubber (NR), butadiene rubber (BR), and any NR and/or BR content of the MWCNT masterbatch, as well as the content of high styrene resin(s), are counted. The content of polyolefin elastomer is not counted. Hence, the sum of the values written in bold and italics gives 100 phr.

Composition C2 is the same as composition E1 except regarding the length of the MWCNT. In composition E1, the MWCNT have an average length ranging from 20 μm to 40 μm. In composition C2, the MWCNT have an average length of about 120 μm.

Composition C3 is the same as composition E2 except regarding the length of the MWCNT. In composition E2, the MWCNT have an average length ranging from 5 μm to 35 μm. In composition C3, the MWCNT have an average length of about 1.5 μm.

The physical characteristics of the tested compositions are reported in Tables 2 and 3. As shown in Table 2, Composition E3 differs from Composition E1 in that a small amount of accelerator TBzTD is added and the content of polyolefin copolymer is lesser. Although Composition E3 has an improved (smaller) tan δ, the Modulus at 10% and 100% is slightly reduced compared to Composition E1. The Comparative composition C1 uses Nanocyl 7000 MWCNT, characterized by MWCNTs having an average length of 1.5 μm and an average wall diameter of 9.5 nm. As shown in Table 2, the three compositions according to the present disclosure E1 to E3 present better tan δ, compared to Comparative composition C1, which is related to a better energy consumption performance. Elongation of compositions E1 to E3 according to the present disclosure is increased compared to the elongation of Comparative composition C1. The anti-crack resistance is either comparable (compositions E2 and C1) or improved such as for compositions E1 and E3 when compared to comparative composition C1, as expressed by the higher number of cycles at failure for E1 and E3, and even a higher number of cycles at half width failure for composition E1.

In Table 3, a comparison of the effect of the length of the MWCNT on the properties of the tested compositions is provided. It is noted that in Table 3, the result of the Comparative compositions C2 and C3 are provided in base 100 compared to inventive Compositions E1 and E2 respectively. Higher base 100 index means better for performance. Lower base 100 index means a decrease of the considered property. For example, for tan δ, a lower index means a higher tan δ in absolute value, which is not wished since high tan δ means high hysteresis of the composition. As another example, when base 100 index is lower in crack resistance, then crack resistance value was lower, which means worse.

TABLE 1
Constituents of the rubber compositions and their content

| | | Chemical | | Composition | Composition | Composition | Composition |
|---|---|---|---|---|---|---|---|
| Density | Raw material | name/category | Producer(s) | C1 | E1 | E2 | E3 |
| 1.35 | Sulphur | | | 1.1 | 2.2 | 2.5 | 2.2 |
| 1.3 | TBBS | N- tert-butyl- | | 2.9 | 1.2 | 1.4 | 1.2 |
| | | benzothiazole | | | | | |
| | | sulfonamide | | | | | |
| 1.2 | TBzTD | Tetrabenzylthiuram | | | | | 0.2 |
| | | disulfide | | | | | |
| 1.3 | PVI | Pre vulcanization | | 0.2 | 0.4 | 0.4 | 0.4 |
| | | inhibitor | | | | | |
| 1.02 | 6PPD or 4020 | Antiozonant | | 2.1 | 1.8 | 2 | 1.8 |
| 1.07 | Vulkanox HS | Antioxidant | | 2.1 | 1.8 | 2 | 1.8 |
| 0.92 | Antilux 654 | Wax | | 2.1 | 1.8 | 2 | 1.8 |
| 0.84 | Stearic acid | | | 2.1 | | 2 | |
| 1.24 | ACT 73-A | Activator | Struktol | | 1.8 | | 1.8 |
| 5.61 | Zinc Oxide 99.9% | | | 4.2 | 3.5 | 4 | 3.5 |
| 1.8 | N 134 Carbon | Carbon black | Cabot | | 8.8 | 8 | 8.8 |
| 1.8 | N 339 Carbon | Carbon black | Cabot | 10.5 | | | |
| 1.39 | Polyester Fiber | | Finite Fiber | | 2.7 | 3 | 2.7 |
| 1 | MWCNT nd-BR | MWCNT in BR | Kumho | 34.7 | | | |
| | MB (10%) | | | | | | |
| 1.05 | MWCNT NR MB | MWCNT in NR | Nanocyl | 63.2 | | | |
| | Nanocyl | | | | | | |
| 1 | MWCNT nd-BR | MWCNT in BR | Kumho | | 47.7 | | 47.7 |
| | MB (20%) | | | | | | |
| 1 | MWCNT NR MB | MWCNT in NR | Arkema | | | 50 | |
| | (20%) | | | | | | |
| 1.1 | Structol 40 MS | Homogenizer | Stuktol | 3.7 | 2.7 | 3 | 2.7 |
| 1 | HSR 68/KER1904 | High styrene resins | Kumho/Synthos | 18.0 | 17.7 | 20 | 17.7 |
| 1.17 | P55 Resin/Durez | Phenolic resin | Akrochem/SBHPP | | 5.3 | 6 | 5.3 |
| | 34218 | reinforcing | | | | | |
| 0.91 | Engage 8540/ | Polyolefin copolymer | Dow/LG | | 13.3 | 5 | 4.4 |
| | LC100 | (poly octene-ethylene) | | | | | |
| 0.94 | RSS3 | Natural rubber | Vietnam | | 44.2 | 10 | 44.2 |
| 0.92 | TSR SIR 20 | Natural rubber | Indonesia | | | | |
| 0.91 | Nd-BR MV 44 | Butadiene rubber | Kumho/Arlanxeo | | | 30 | |
| | MWCNT nd-BR | BR | Kumho nd-BR 40 | 31.3 | | | |
| | MB (10%) | MWCNT | Kumho MWCNT | 3.4 | | | |
| | MWCNT NR MB | NR | | 50.7 | | | |
| | Nanocyl | MWCNT | Nanocyl MWCNT | 12.5 | | | |
| | MWCNT nd-BR | BR | Kumho nd-BR 40 | | 38.2 | | 38.2 |
| | MB (20%) | MWCNT | Kumho MWCNT | | 9.54 | | 9.54 |
| | MWCNT NR MB | NR | | | | 40 | |
| | (20%) | MWCNT | Arkema MWCNT | | | 10 | |
| | | | MWCNT per | 10.8% | 6.1% | 6.6% | 6.4% |
| | | | composition | | | | |
| | | | Density calculated | 1.090 | 1.038 | 1.037 | 1.047 |
| | | | Actual density | 1.06 | 1.034 | 1.049 | 1.038 |

TABLE 2
Properties of the rubber compositions

| | | | Composition | Composition | Composition | Composition |
|---|---|---|---|---|---|---|
| | | | C1 | E1 | E2 | E3 |
| Physical | Hardness ASTM D-2240 (Shore A) | | 86 | 80 | 85 | 82 |
| Properties | Tensile | Tensile (ASTM D-412-A) (MPa) | 15 | 16.6 | 16.7 | 14.9 |
| (Rigidity etc.) | | Elongation (ASTM D-412-A) (%) | 265 | 430 | 387 | 373 |
| | | Modulus 10% (ASTM D-412-A) (MPa) | 2.02 | 1.81 | 2.63 | 1.77 |
| | | Modulus 100% (ASTM D-412-A) (MPa) | 8.55 | 6.32 | 7.17 | 5.9 |
| | | Modulus 300% (ASTM D-412-A) (MPa) | N/A | 12.37 | 13.39 | 12.63 |
| | Tear strength (ASTM D-624 die C) (KN/m) | | 58.9 | 50.7 | 44.5 | 51 |
| | Compression modulus (ASTM D-575 method A) (MPa) | | 3.6 | 3.06 | 3.95 | 3.02 |
| Anti-crack | De Mattia | De Mattia crack initiation (kcycles) | 10 | 10 | 10 | 10 |
| resistance | (ASTM | Cycles at half width failure (kcycles) | 10 | 30 | 10 | 10 |
| | D86013-95) | Cycles at failure (kcycles) | 10 | 60 | 10 | 20 |
| Dynamic | RPA* strain | G′, storage Modulus @ 10% strain (MPa) | 3.484 | 2.759 | 3.057 | 2.807 |
| properties | sweep (shear), | G″, Loss Modulus @ 10% strain (MPa) | 1.042 | 0.509 | 0.561 | 0.497 |
| | 60° C., 10 Hz | Tan δ @ 10% strain | 0.2993 | 0.185 | 0.184 | 0.177 |

*RPA: rubber process analyzer

TABLE 3
Comparison of the effects of the length of the MWCNT on the properties of the rubber compositions

| | | | Composition | Composition | Composition | Composition |
|---|---|---|---|---|---|---|
| | | | E1 | C2 | E2 | C3 |
| Commercial name the MWCNT | | | Kumho | Kumho | Arkema | Nanocyl |
| | | | BND230 | BND-400T | MWCNT | MWCNT |
| Length of the MWCNT | | | 20-40 μm | 120 μm | 5-35 μm | 1.5 μm |
| Diameter of the MWCNT | | | 19 nm | 20 nm | 12 nm | 9.5 nm |
| Physical | Hardness ASTM D-2240 | | 100 | 106 | 100 | 102 |
| Properties | Tensile | Tensile (ASTM D-412-A) | 100 | 78 | 100 | 92 |
| (Rigidity | | Elongation (ASTM D-412-A) | 100 | 86 | 100 | 103 |
| etc.) | | Modulus 10% (ASTM D-412-A) | 100 | 122 | 100 | 98 |
| | | Modulus 100% (ASTM D-412-A) | 100 | 136 | 100 | 101 |
| | | Modulus 300% (ASTM D-412-A) | 100 | 96 | 100 | 105 |
| | Tear strength (ASTM D-624 die C) | | 100 | 115 | 100 | 101 |
| | Compression modulus (ASTM D-575 method A) | | 100 | 131 | 100 | 117 |
| Anti-crack | De Mattia | De Mattia crack initiation | 100 | 100 | 100 | 100 |
| resistance | (ASTM | Cycles at half width failure | 100 | 50 | 100 | 100 |
| | D86013-95) | Cycles at failure | 100 | 43 | 100 | 100 |
| Dynamic | RPA strain | G′, storage Modulus @ 10% strain | 100 | 117 | 100 | 120 |
| properties | sweep (shear), | G″, Loss Modulus @ 10% strain | 100 | 71 | 100 | 77 |
| | 60° C., 10 Hz | Tan δ @ 10% strain | 100 | 90 | 100 | 97 |

From the data reported in Table 3, it can be noted that longer MWCNT (composition C2) decrease the mechanical properties of the compositions (tensile strength and elongation), the anti-crack resistance performance and hysteretic performance.

Shorter MWCNT (composition C3) decrease the tensile strength and hysteretic performances but does not affect anti-crack resistance performance.

A lower hysteretic performance implies that more energy is necessary for using a track made of the rubber composition (e.g., snowmobile track) and that the life of application (track life) will be shortened/reduced.

Any feature of any embodiment described herein may be used in combination with any feature of any other embodiment described herein. Certain additional elements that may be needed for operation of some embodiments have not been described or illustrated as they are assumed to be within the purview of those of ordinary skill in the art. Moreover, certain embodiments may be free of, may lack and/or may function without any element that is not specifically disclosed herein.

Although various embodiments and examples have been presented, this was for purposes of description, but should not be limiting. Various modifications and enhancements will become apparent to those of ordinary skill in the art.

1.-20. (canceled)

21. A rubber composition based on:
65 wt % to 80 wt % of an elastomeric material comprising at least a mixture of a polyisoprene, a butadiene rubber, and a polyolefin elastomer;
1 wt % to 7 wt % of multi-walled carbon nanotubes;
3 wt % to 25 wt % of carbon black; and
0 to 2 wt % of fibers,
wherein the weight percentages, wt %, are based on a total weight the rubber composition; and
wherein the multi-walled carbon nanotubes have an average length ranging from 2 μm to 40 μm.

22. The rubber composition of claim 21, wherein the elastomeric material comprises:
25 wt % to 35 wt % of the polyisoprene;
17 wt % to 27 wt % of the butadiene rubber; and
3 wt % to 9 wt % of the polyolefin elastomer.

23. The rubber composition of claim 21, wherein the elastomeric material further comprises 10 wt % to 15 wt % of a high styrene resin.

24. A rubber composition based on:
25 wt % to 35 wt % of a polyisoprene;
17 wt % to 27 wt % of a butadiene rubber;
3 wt % to 9 wt % of a polyolefin elastomer;
10 wt % to 15 wt % of a high styrene resin;
1 wt % to 7 wt % of multi-walled carbon nanotubes;
3 wt % to 25 wt % of carbon black; and
0 to 2 wt % of fibers,
wherein weight percentages, wt %, are based on a total weight the rubber composition.

25. The rubber composition of claim 24, wherein the multi-walled carbon nanotubes have an average length ranging from 2 μm to 40 μm.

26. The rubber composition of claim 21, wherein the polyisoprene is selected from the group consisting of natural rubber, synthetic polyisoprenes, and mixtures thereof.

27. The rubber composition of claim 21, wherein the polyolefin elastomer comprises poly octene-ethylene.

28. The rubber composition of claim 21, wherein the rubber composition has a density ranging from 1.02 kg/L to 1.095 kg/L.

29. The rubber composition of claim 21, wherein the multi-walled carbon nanotubes have an average length ranging from 5 μm to 35 μm.

30. The rubber composition of claim 21, wherein the multi-walled carbon nanotubes have a BET specific surface area ranging from 200 m²/g to 250 m²/g.

31. The rubber composition of claim 21, wherein the multi-walled carbon nanotubes have an average diameter ranging from 10 nm to 20 nm.

32. The rubber composition of claim 21, comprising from 2 wt % to 7 wt % of multi-walled carbon nanotubes.

33. The rubber composition of claim 21, wherein the rubber composition comprises from 3 wt % to 9 wt % of carbon black.

34. The rubber composition of claim 21, wherein a weight ratio of the multi-walled carbon nanotubes to the carbon black in the composition ranges from 1.09 to 1.2.

35. The rubber composition of claim 21, wherein the fibers comprise polyester fibers.

36. The rubber composition of claim 21, comprising from 1 wt % to 2 wt % of fibers.

37. The rubber composition of claim 21, comprising from 27 wt % to 33 wt % of the polyisoprene, and 18 wt % to 25 wt % of the butadiene rubber.

38. A track for a vehicle comprising the rubber composition of claim 21 in vulcanized form.

39. The track according to claim 38, wherein the track is a snowmobile track.

40. The rubber composition of claim 24, wherein the polyolefin elastomer comprises a copolymer of ethylene as a first olefin and a second olefin comprising at least 3 carbon atoms.
